(19) United States
(12) Patent Application Publication
(10) Pub. No.: US 2006/0017695 A1
(43) Pub. Date: Jan. 26, 2006

(54) Static free device for a computer mouse

(76) Inventor: Chung-Fen Wu, Changhau Hsien (TW)

Correspondence Address: Jackson Walker L.L.P., Suite 2100, 112 E. Pecan Street, San Antonio, TX, 78205, US

(21) Appl. No.: 10/898,840

(22) Filed: Jul. 26, 2004

(51) Int. Cl. G09G 5/08

(52) U.S. Cl. 345/163

(57) ABSTRACT

A static free device for a computer mouse having a cover and a connection line extending out from the computer mouse for connection with a computer includes a metallic conductor adapted for mounting on the cover and a ground line having a protection device thereon and provided with a first end in electrical connection with the metallic conductor and a second end extending out for ground connection such that static on the cover is able to be discharged via the ground line.

### BACKGROUND OF THE INVENTION

1. Field of the Invention

The present invention relates to a computer mouse, and more particularly to static free device in a computer mouse to entirely remove static in the computer mouse casing to avoid absorption of the static by the user such that static accumulation on the user is obviated.

2. Description of Related Art

There are a lot of materials, e.g. furs, plastics in our daily life that generate static current which is easily transferred to the human body. When living in high rising buildings, people are surrounded by objects made of insulated materials such that static in the human body is gradually accumulated to a highly dangerous extent. Therefore, people often see discharge on dry days, which is a sign to indicate that the static potential inside the human body is too high.

Health experts warn people that when the static potential rises to a certain extent, a negative effect is expected to interfere with their health and proper precaution is necessary. Medical experts affirm that skin static interference may change normal electric potential on the human skin, affect normal cardiovascular muscle function and influence normal human health.

Beside the negative influence by static to our lives, due to advanced micro electronic engineering, people are becoming more and more concerned about living in a static free environment and issues such EMI (electromagnetic interference) and EMC (electromagnetic compatibility). Laboratories, research institutes and the like are very concerned about the static carried by the human body. That is, when people are working in a highly insulated environment, the static carried by the human body will cause serious problems to microelectronic products that require only millivolts to operate. In order to obviate these problems caused by static, products such as static free gloves, shoes, robes, masks, hats and even floors are developed to the market to improve the working environment.

Furthermore, because computers have become indispensable tools in the 21st century, static caused by the friction between the computer mouse and the mouse pad is accumulated by the users such that the user's health is gradually influenced by the static.

To overcome the shortcomings, the present invention tends to provide an improved computer mouse to mitigate the aforementioned problems.

### SUMMARY OF THE INVENTION

The primary objective of the present invention is to provide an improved static free device to discharge static carried by the user so as to assure the user of unimpaired health as regards static.

In order to accomplish the aforementioned objective, a static free device for a computer mouse having a cover and a connection line extending out from the computer mouse for connection with a computer includes a metallic conductor adapted for mounting on the cover and a ground line having a protection device thereon and provided with a first end in electrical connection with the metallic conductor and a second end extending out for ground connection such that static on the cover is able to be discharged via the ground line.

Other objects, advantages and novel features of the invention will become more apparent from the following detailed description when taken in conjunction with the accompanying drawings.

### BRIEF DESCRIPTION OF THE DRAWINGS

FIG. 1 is a schematic top plan view showing the static free device in a computer mouse;

FIG. 2 is a schematic top plan view showing the second embodiment of the static free device in a wireless computer mouse;

FIG. 3 is a schematic top plan view showing the third embodiment of the static free device;

FIG. 4 is a schematic side plan view showing the integration of the static free device and the computer mouse connection line;

FIG. 5 is a schematic view showing the application of the first embodiment of the present invention to a computer; and

FIG. 6 is a schematic view showing the application of the third embodiment of the present invention to a computer.

### DETAILED DESCRIPTION OF THE PREFERRED EMBODIMENT

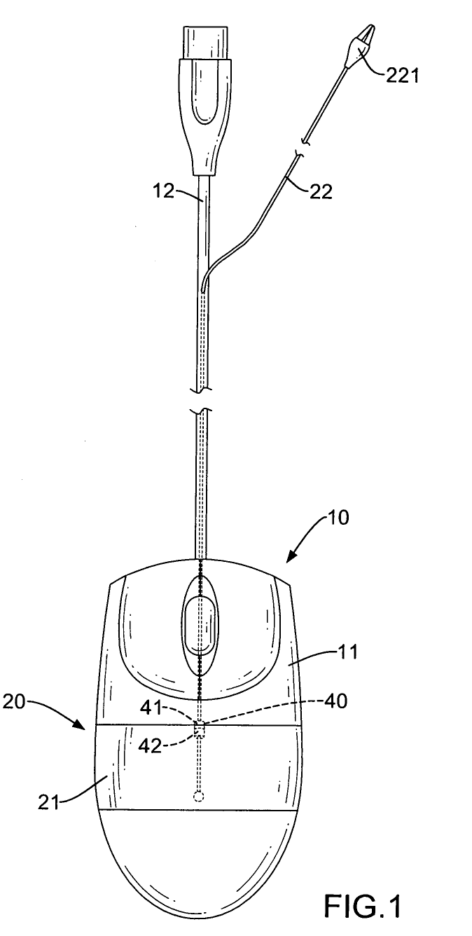

With reference to FIG. 1, a computer mouse (10) is provided with a cover (11) and a connection line (12) for connection to a computer casing (not shown). The static free device (20) in accordance with the present invention includes a metallic conductor (21) mounted on top of the cover (11) and a ground line (22) having a first end in electrical connection to the metallic conductor (21) and a second end (221) extending out for ground. A protection device (40) composed of a diode (41) and a resistor (42) in series with the diode (41) is provided on the ground line (22) to protect the user from electrical surge coming from an object to which the second end (221) is connected.

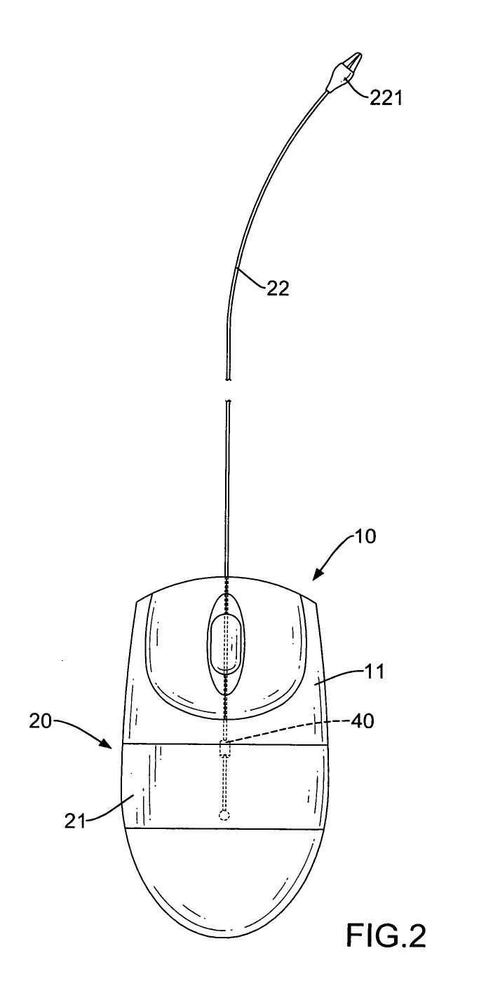

With reference to FIG. 2, it is noted that the computer mouse is a wireless mouse such that there is no connection line (12) as that depicted in FIG. 1. However, the static free device (20) may still be applied to the wireless computer mouse.

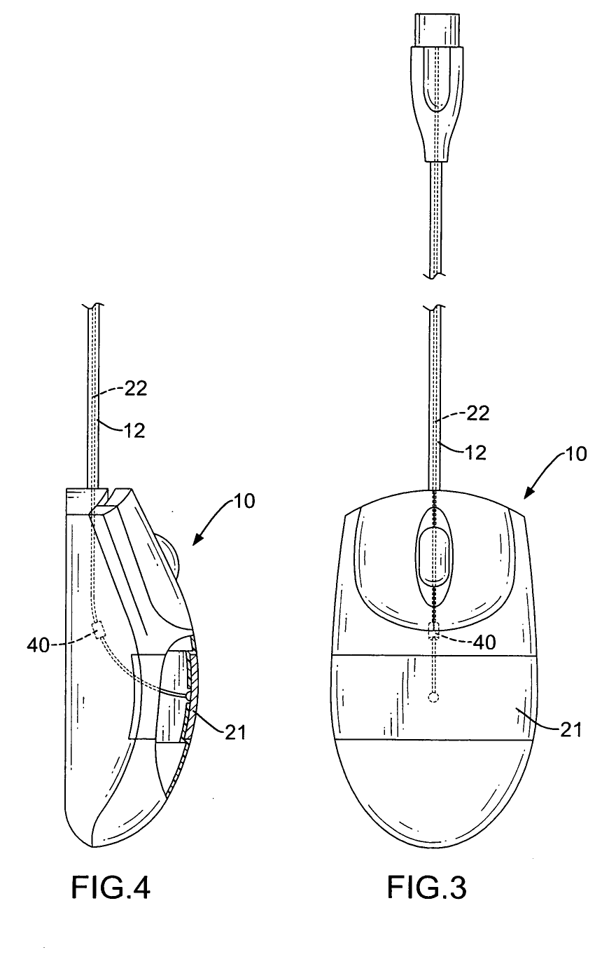

With reference to FIGS. 3 and 4, it is noted that the ground line (22) is integrated with the connection line (12) so that the overall appearance of the computer mouse (10) is especially compact.

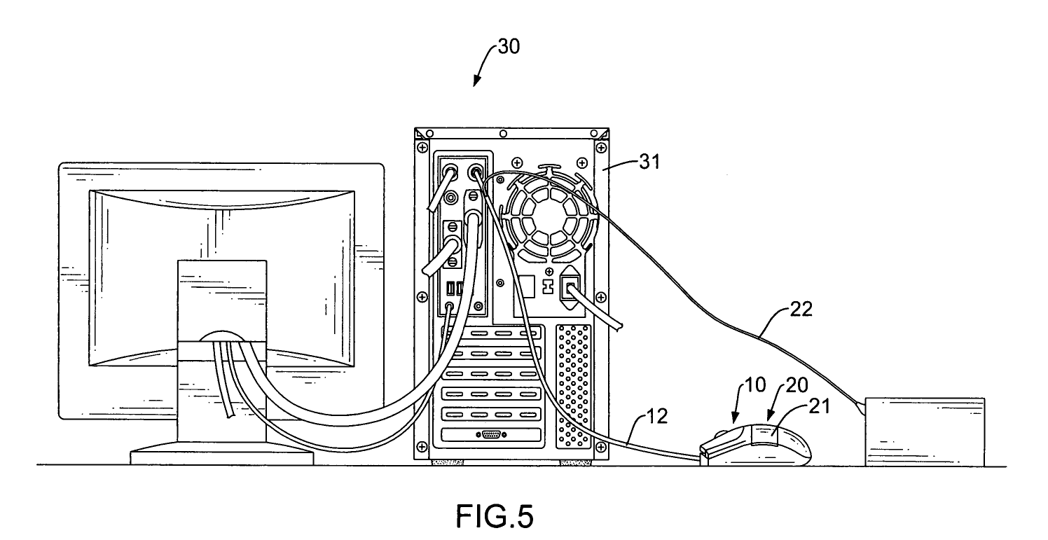

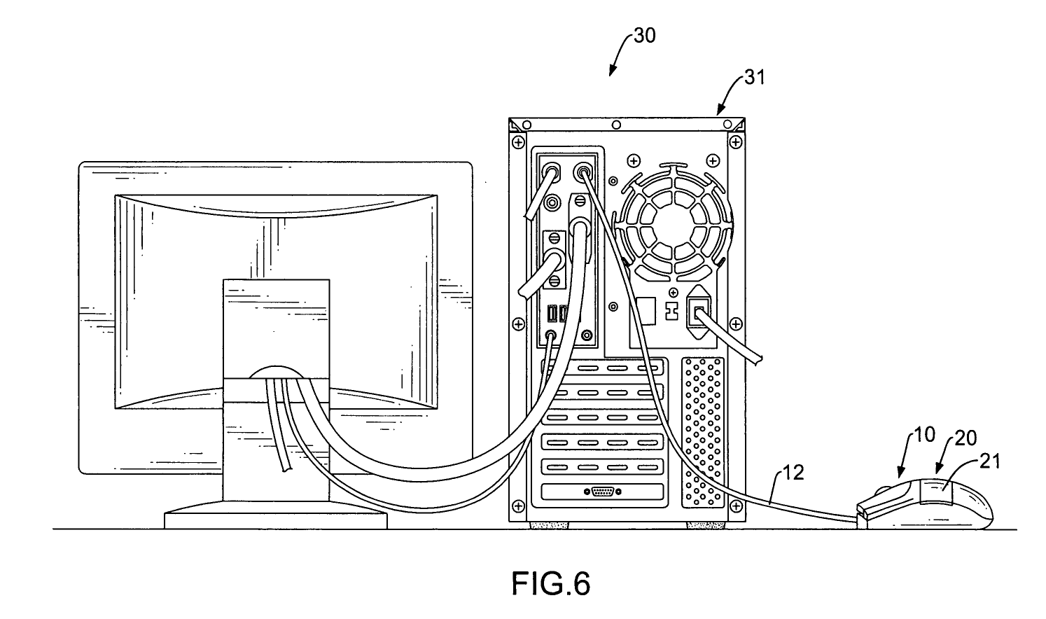

With reference to FIGS. 5 and 6, it is noted that when the computer mouse (10) of the present invention is in application, the connection line (12) is connected to a casing (31) of a computer (30) and the ground line (22) may connect to a ground device fitted to the exterior of the computer (30). When the computer mouse (10) is a wireless mouse as shown in FIG. 2 and when the connection line (12) is connected to the computer casing (31), the ground of the computer mouse (10) is completed.

As a result of the provision of the static free device (20) inside the computer mouse (10), the static carried by human body is able to be discharged via the ground line (22) such that the user's health is unimpaired by the static. Furthermore, because of the protection device (40), electrical surge or electrical current from the ground (computer casing) is not able to flow backward to damage the computer mouse (10) and the user.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. In a computer mouse having a cover and a connection line extending out from the computer mouse for connection with a computer, wherein the improvements comprise:
a metallic conductor adapted for mounting on the cover; and
a ground line having a protection device thereon with a first end in electrical connection with the metallic conductor and a second end extending out for ground connection such that static on the cover is able to be discharged via the ground line.

2. The computer mouse as claimed in claim 1, wherein the protection device is a diode.

3. The computer mouse as claimed in claim 1, wherein the protection device further has a resistor in series with the diode.

4. The computer mouse as claimed in claim 1, wherein the protection device is a diode and a resistor in series with the diode.

5. The computer mouse as claimed in claim 1, wherein the ground line is adapted for integration with the connection line.

6. The computer mouse as claimed in claim 2, wherein the ground line is adapted for integration with the connection line.

7. The computer mouse as claimed in claim 3, wherein the ground line is adapted for integration with the connection line.

8. The computer mouse as claimed in claim 4, wherein the ground line is adapted for integration with the connection line.
